(19) United States
(12) Patent Application Publication
(10) Pub. No.: US 2013/0285996 A1
(43) Pub. Date: Oct. 31, 2013

(54) ORGANIC LIGHT EMITTING DISPLAY APPARATUS AND METHOD OF INSPECTING THE SAME

(71) Applicant: SAMSUNG DISPLAY CO., LTD., Yongin-city (KR)

(72) Inventors: June-Woo Lee, Yongin-city (KR); Jae-Beom Choi, Yongin-city (KR); Kwan-Wook Jung, Yongin-city (KR); Sung-Soo Choi, Yongin-city (KR); Seong-Jun Kim, Yongin-city (KR); Guang-Hai Jin, Yongin-city (KR); Ga-Young Kim, Yongin-city (KR); Jee-Hoon Kim, Yongin-city (KR)

(73) Assignee: Samsung Display Co., Ltd., Yongin-city (KR)

(21) Appl. No.: 13/647,699

(22) Filed: Oct. 9, 2012

(30) Foreign Application Priority Data
Apr. 25, 2012 (KR) 10-2012-0043479

(51) Int. Cl. G09G 5/00; G09G 3/30

(52) U.S. Cl. 345/211; 345/76

(57) ABSTRACT

An organic light emitting display apparatus and a method of easily inspecting the apparatus to determine whether an electrical failure occurs are disclosed. The organic light emitting display apparatus includes a plurality of pixels each including a pixel electrode, an intermediate layer including an organic emission layer, and an opposite electrode, pluralities of scan lines and data lines corresponding to the plurality of pixels, first power supply lines connected to the plurality of pixels and extending in a first direction; second power supply lines connected to the first power supply lines, and a controller that simultaneously supplies control signals to the plurality of pixels, and includes a plurality of control lines and a common line. The common line is connected to a first end of each of the plurality of control lines and is separated from a second, opposing end of each of the plurality of control lines.

### CROSS-REFERENCE TO RELATED APPLICATIONS

This application claims the benefit of Korean Patent Application No. 10-2012-0043479, filed on Apr. 25, 2012, in the Korean Intellectual Property Office, the disclosure of which is incorporated herein in its entirety by reference.

### BACKGROUND

1. Field

One or more aspects of the present invention relate to an organic light emitting display apparatus and a method of inspecting the same, and more particularly, to an organic light emitting display apparatus that can be easily inspected to determine whether an electrical failure occurs and a method of inspecting the organic light emitting display apparatus.

2. Description of the Related Technology

Recently, display apparatuses have been replaced with portable thin film flat panel display apparatuses. An organic light emitting display apparatus is a self-emitting display apparatus and has a larger viewing angle, better contrast characteristics, and a faster response speed, compared to other flat panel display apparatuses. Thus, the organic light emitting display apparatus has drawn attention as a next-generation display apparatus.

An organic light-emitting display apparatus includes an intermediate layer, a first electrode, and a second electrode. The intermediate layer includes an organic emission layer. When a voltage is applied to the first and second electrodes, visible light is emitted from the organic emission layer.

### SUMMARY OF CERTAIN INVENTIVE ASPECTS

According to an aspect of the present invention, there is provided an organic light emitting display apparatus including a plurality of pixels each including a pixel electrode, an intermediate layer including an organic emission layer, and an opposite electrode; a plurality of scan lines and a plurality of data lines corresponding to the plurality of pixels; first power supply lines connected to the plurality of pixels and extending in a first direction; second power supply lines connected to the first power supply lines; and a controller for simultaneously supplying control signals to the plurality of pixels, the controller including a plurality of control lines and a common line, wherein the common line is connected to a first of each of the plurality of control lines and is separated to a second, opposing end of each of the plurality of control lines.

The second power supply lines may extend in a second direction intersecting the first direction.

The control lines may extend in the first direction.

The control lines may be disposed on a layer on which the first or second power supply voltages are not disposed, and the first or second power supply voltages, which are disposed on the layer on which the control lines are not disposed, may intersect the control lines.

The control lines may be disposed on a layer on which the first power supply lines are disposed, and may be disposed on a layer on which the second power supply lines are not disposed so as to intersect the second power supply voltages.

The control lines may be disposed on a layer on which the data lines are disposed.

The first power supply lines may be disposed on a layer on which the data lines are disposed.

The second power supply lines may be disposed on a layer on which the scan lines are disposed.

Each of the plurality of pixels may include at least three thin film transistors and at least two capacitors.

The controller may be electrically connected to a gate electrode of one of the at least three thin film transistors.

At least one of the at least three thin film transistors may include an active layer, a first gate electrode layer, a second gate electrode layer formed on the first gate electrode layer, a source electrode, and a drain electrode. The pixel electrode may be formed on a layer on which the first gate electrode layer is formed by using a material used to form the first gate electrode layer.

According to another aspect of the present invention, there is provided a method of inspecting an organic light emitting display apparatus which includes a plurality of pixels each including a pixel electrode, an intermediate layer including an organic emission layer, and an opposite electrode, a plurality of scan lines and a plurality of data lines corresponding to the plurality of pixels, first power supply lines connected to the plurality of pixels and extending in a first direction, second power supply lines connected to the first power supply lines, and a controller that simultaneously supplies control signals to the plurality of pixels and includes a plurality of control lines and a common line connected to a first end of each of the plurality of control lines and separated from a second, opposing end of each of the plurality of control lines, the method including applying a voltage to one of the control lines by connecting a power receiving member to a region of the first end of the control line, which is disposed apart from the common line, and connecting a power feeding member to a region of the control line that is disposed farther from the common line than the region connected to the power receiving member.

The method may further include monitoring a potential difference between the region of the control line connected to the power receiving member and the region of the control line connected to the power feeding member.

The method may further include sequentially applying a voltage to the plurality of control lines by sequentially connecting the power receiving member and the power feeding member to the plurality of control lines.

A voltage may be sequentially applied to the plurality of control lines so as to inspect whether a short circuit failure occurs between each of the control lines and each of the first power supply lines or between each of the control lines and each of the second power supply lines.

### BRIEF DESCRIPTION OF THE DRAWINGS

The above and other features and advantages of the present invention will become more apparent by describing in detail certain embodiments thereof with reference to the attached drawings in which:

FIG. 1 is a schematic plan view of an organic light emitting display apparatus according to an embodiment of the present invention;

FIG. 2 is a diagram schematically illustrating a structure of wires included in region II of FIG. 1, according to an embodiment of the present invention;

FIG. 3 is a circuit diagram of one of pixels included in the organic light emitting display apparatus of FIG. 1, according to an embodiment of the present invention;

FIG. 4 is a diagram schematically illustrating some wires included in the organic light emitting display apparatus of FIG. 1, according to an embodiment of the present invention;

FIG. 5 is an enlarged view of region V of FIG. 4;

FIGS. 6A and 6B are diagrams schematically illustrating a method of inspecting an organic light emitting display apparatus, according to an embodiment of the present invention; and

FIG. 7 is a cross-sectional view of some elements of each pixel of the organic light emitting display apparatus of FIG. 1, according to an embodiment of the present invention.

### DETAILED DESCRIPTION OF CERTAIN INVENTIVE EMBODIMENTS

Various wires are installed in an organic light emitting display apparatus to drive the organic light emitting display apparatus. From among the various wires, some wires may be disposed on different layers to overlap with one another. When a short circuit failure occurs in overlapped regions where the wires overlap, the overlapping wires should be repaired.

However, it is not easy to detect a location of a short circuit failure occurring on such overlapping wire regions. In particular, as the number of wires increases and wires have a more complicated structure, inspecting an organic light emitting display apparatus becomes increasingly difficult.

One or more aspects of the present invention provide an organic light emitting display apparatus which can be easily inspected to determine whether an electrical failure occurs can be easily inspected, and a method of inspecting the organic light emitting display apparatus.

Hereinafter, certain embodiments of the present invention will be described in greater detail with reference to the accompanying drawings.

As used herein, the term “and/or” includes any and all combinations of one or more of the associated listed items. Expressions such as “at least one of,” when preceding a list of elements, modify the entire list of elements and do not modify the individual elements of the list.

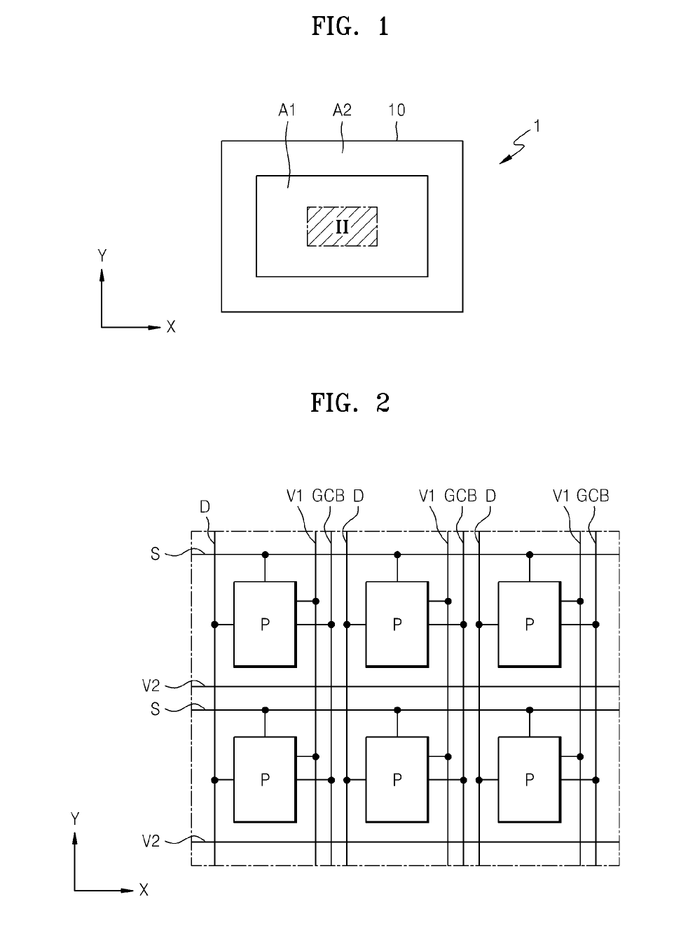

FIG. 1 is a schematic plan view of an organic light emitting display apparatus 1 according to an embodiment of the present invention. FIG. 2 is a diagram schematically illustrating a structure of wires included in region II of FIG. 1, according to an embodiment of the present invention.

Referring to FIGS. 1 and 2, in the organic light emitting display apparatus 1 according to an embodiment, a display region A1 and a non-display region A2 are formed on a substrate 10.

The display region A1 displays an image therein and may be disposed in a region of the substrate 10 including a center of the substrate 10. The non-display region A2 may be disposed on the substrate 10 to surround the display region A1.

As seen in FIG. 2, a plurality of pixels P forming an image are included in the display region A1.

The plurality of pixels P may be defined as scan lines S extending in a first direction (such as for example in an X-axis direction) and data lines D extending in a second direction (such as for example in a Y-axis direction) perpendicular to the first direction (X-axis direction). A data signal provided from a data driver (not shown) included in the non-display region A2 is supplied to the plurality of pixels P via the data lines D, and a scan signal provided from a scan driver (not shown) included in the non-display region A2 is supplied to the plurality of pixels P via the scan lines S. Although FIG. 2 illustrates that the data lines D extend in the second direction and the scan lines S extend in the first direction, the present invention is not limited thereto. The directions in which the data lines D and the scan lines S respectively extend may be different than the ones mentioned above.

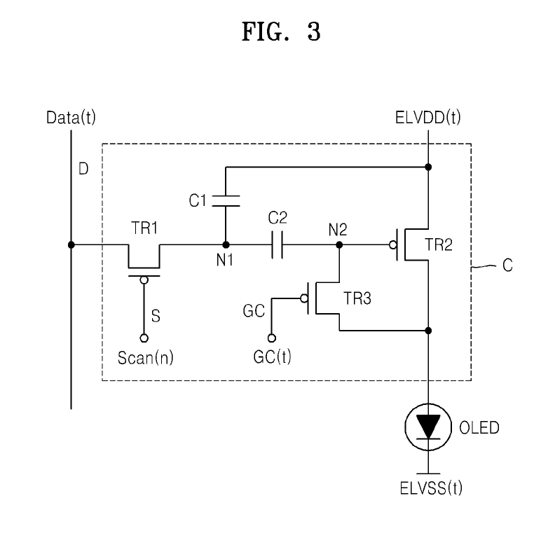

The plurality of pixels P are connected to first power supply lines V1 extending in the second direction (Y-axis direction). A first power supply voltage ELVDD (see FIG. 3) provided from a first power supply driver (not shown) is applied to the plurality of pixels P via the first power supply lines V1. A power supply voltage ELVSS (see FIG. 3) is applied to the plurality of pixels P. The plurality of pixels P control the amount of current supplied to a power supply voltage source ELVSS(t) from the first power supply voltage ELVDD via an organic light emitting device OLED, according to a data signal. Then, the organic light emitting device OLED generates light having a desired brightness.

Second power supply lines V2 extending in the first direction (X-axis direction) are connected to the first power supply lines V1. A voltage drop (IR drop) may occur in the first power supply voltages line V1 due to resistance when the first power supply lines V1 are long. This problem may be solved by connecting the second power supply lines V2 to the first power supply lines V1.

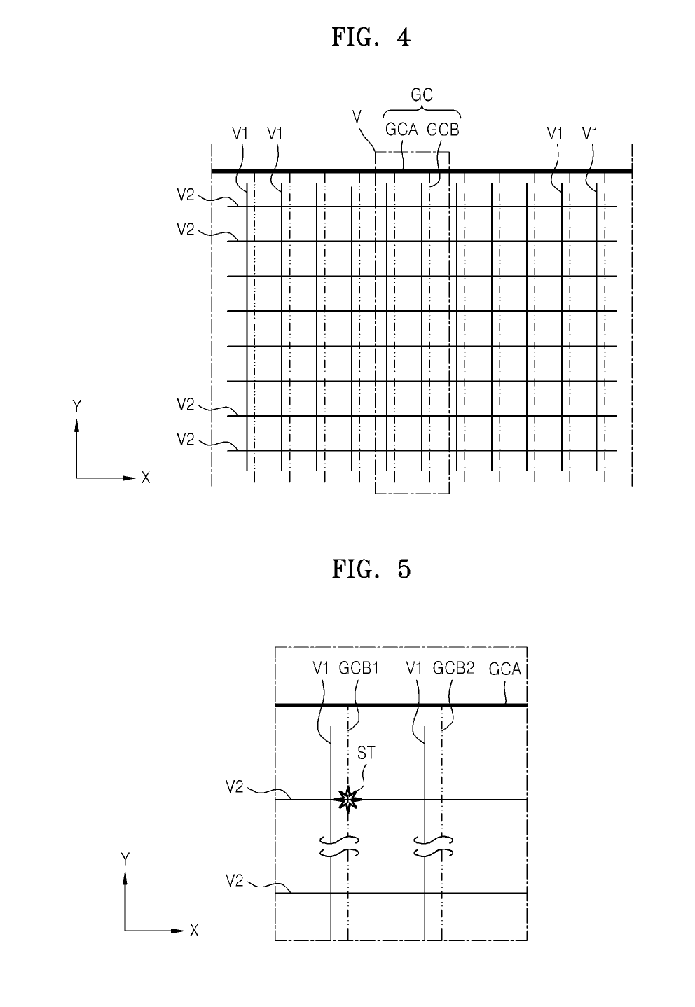

Each of the plurality of pixels P is connected to one of control lines GCB of a control line unit (or controller). The plurality of pixels P are connected to the control lines GCB that branch off from one wire and that extend in the second direction. The control line unit including the control lines GCB is described with reference to FIG. 4 below.

Control signals having a predetermined voltage provided from a control signal driver (not shown) included in the non-display region A2 are simultaneously applied to the plurality of pixels P via the control lines GCB.

FIG. 3 is a circuit diagram of one of pixels included in the organic light emitting display apparatus 1 of FIG. 1, according to an embodiment of the present invention.

Referring to FIG. 3, the pixel includes the organic light emitting device OLED, and a pixel circuit C for supplying current to the organic light emitting device OLED.

In the organic light emitting device OLED, a pixel electrode is connected to the pixel circuit C and an opposite electrode is connected to the power supply voltage source ELVSS(t). The organic light emitting device OLED generates light having a brightness corresponding to current supplied from the pixel circuit C.

An active matrix organic light emitting display apparatus includes two transistors and one capacitor. The active matrix organic light emitting display apparatus includes a switching transistor for delivering a data signal, a driving transistor for driving an organic light emitting device according to the data signal, and a capacitor for maintaining a data voltage constant.

In such an organic light emitting display apparatus including two transistors and one capacitor, power consumption is low. The intensity of current flowing through an organic light emitting device may vary according to a deviation in a voltage between a gate and source of a driving transistor that drives the organic light emitting diode, such as for example, a deviation in a threshold voltage of the driving transistor. Thus, display quality may be degraded. To solve this problem, at least three transistors or at least two capacitors may be included in an organic light emitting display apparatus in some embodiments.

In the organic light emitting display apparatus 1 according to one embodiment, each of pixels may include three transistors TR1 to TR3 and two capacitors C1 and C2, as shown in FIG. 3.

In the first transistor TR1, a gate electrode is connected to a scan line S, a first electrode is connected to a data line D, and a second electrode is connected to a first node N1. A scan signal Scan(n) is supplied to the gate electrode of the first transistor TR1 and a data signal Data(t) is supplied to the first electrode of the first transistor TR1.

In the second transistor TR2, a gate electrode is connected to a second node N2, a first electrode is connected to a first power supply voltage source ELVDD(t), and a second electrode is connected to the pixel electrode of the organic light emitting device OLED. The second transistor TR2 acts as a driving transistor.

The first capacitor C1 is connected between the first node N1 and the first electrode of the second transistor TR2, i.e., the first power supply voltage source ELVDD(t). The second capacitor C2 is connected between the first node N1 and the second node N2.

In the third transistor TR3, a gate electrode is connected to a control line unit GC, a first electrode is connected to the gate electrode of the second transistor TR2, and a second electrode is connected to the pixel electrode of the organic light emitting device OLED, i.e., the second electrode of the second transistor TR2. Thus, a control signal GC(t) is supplied to the gate electrode of the third transistor TR3.

Although FIG. 3 illustrates a case where each of pixels includes three transistors and one capacitor, the present invention is not limited thereto. In order to compensate for a threshold voltage, at least three transistors and/or at least one capacitor may be included in each of pixels of an organic light emitting display apparatus.

FIG. 4 is a diagram schematically illustrating some wires included in the organic light emitting display apparatus 1 of FIG. 1, according to an embodiment of the present invention. For convenience of explanation, only a control line unit GC, first power supply lines V1, and second power supply lines V2 are illustrated in FIG. 4.

The control line unit GC includes a common line GCA and a plurality of control lines GCB. As described above, the control lines GCB extend in a second direction (Y-axis direction) to supply a control signal to pixels. The control lines GCB are connected to one common line GCA. The common line GCA is connected to an end of each of the control lines GCB. Thus, signals that branch off from a common signal received via the one common line GCA may be supplied to the control lines GCB.

The first power supply lines V1 and the second power supply lines V2 are connected to each other. Specifically, the first power supply lines V1 and the second power supply lines V2 may be formed on different layers to be connected to each other via a contact hole (not shown).

The control line GCB is formed on a layer that is different from a layer on which the first power supply lines V1 or the second power supply lines V2 are formed. In one embodiment, the control line GCB and the second power supply lines V2 are formed on different layers. To this end, at least one insulating layer may be disposed between the control line GCB and the second power supply lines V2.

During manufacture of the organic light emitting display apparatus 1, the control line GCB and the second power supply lines V2 formed on different layers may be connected to one another due to undesired particles, thereby causing an error to occur. In particular, the control line GCB and the second power supply line V2 may be connected to one another in regions where the second power supply lines V2 and the control line GCB overlap with each other, thereby causing a short circuit failure to occur, as described with reference to FIG. 5 below.

FIG. 5 is an enlarged view of a region OV of FIG. 4. Referring to FIG. 5, a short circuit failure ST occurs in a region where one control line CGB1 of the control line unit GC overlaps with a second power supply line V2, due to foreign substances, e.g., undesired particles. To improve image quality of the organic light emitting display apparatus 1, a repair process is performed to rectify the short circuit failure ST. To perform the repair process, a process of detecting a location of the short circuit failure ST should be first performed.

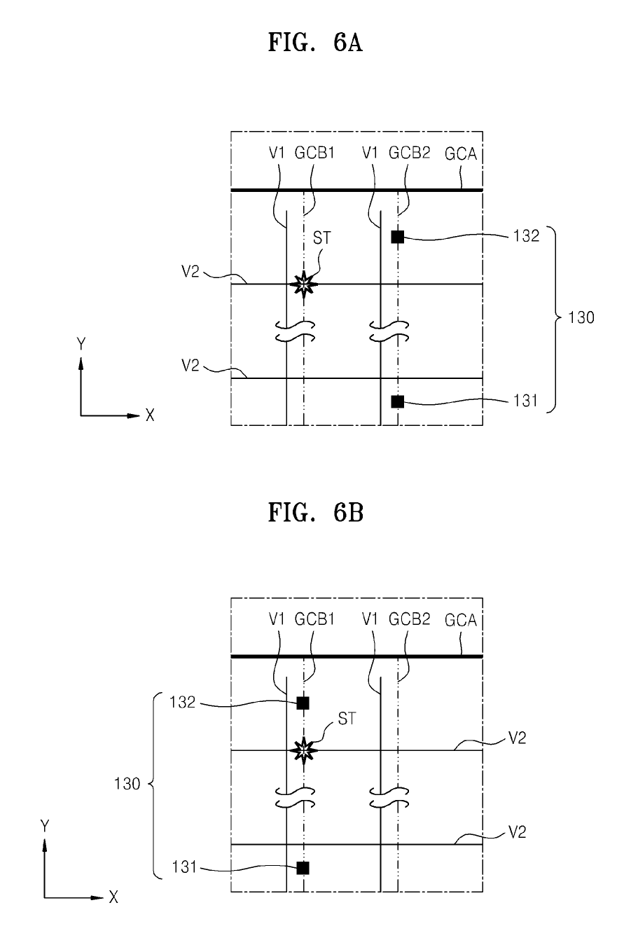

FIGS. 6A and 6B are diagrams schematically illustrating a method of inspecting an organic light emitting display apparatus, according to an embodiment of the present invention.

Referring to FIG. 6A, a test device 130 including a power feeder 131 and a power receiver 132 is prepared. Then, the power feeder 131 and the power receiver 132 are sequentially connected to control lines GCB of a control line unit GC. The power feeder 131 and the power receiver 132 are not connected to first power supply lines V1 and second power supply lines V2. Because the first power supply line V1 and the second power supply line V2 are connected in a mesh shape, current flows through all the first and second power supply lines V1 and V2, when a voltage is applied to the first power supply line V1 and the second power supply line V2 via the test device 130 to inspect the organic light emitting display apparatus. Thus, it is difficult to determine whether a short circuit failure occurs in the organic light emitting display apparatus.

Referring to FIG. 6A, first, the power feeder 131 and the power receiver 132 are connected to a control line GCB2 of the control line unit GC.

The power feeder 131 is connected to a lower portion of the control line GCB2 and the power receiver 132 is connected to an upper portion of the control line GCB2. The power feeder 131 is disposed farther from a common line GCA of the control line unit GC and the power receiver 132 is disposed closer to the common line GCA. Then, when a voltage is applied to the control line GCB2 by using the power feeder 131 and the power receiver 132, current flows through the control line GCB2. A potential difference occurs at both ends of the control line GCB2. Such a potential difference is monitored. Unlike as described above, when the power feeder 131 and the power receiver 132 are connected to the upper portion and the lower portion of the control line GCB2, respectively, current is likely to flow through the common line GCA adjacent to the power feeder 131 due to a voltage applied via the power feeder 131. Thus, it is difficult to exactly monitor a potential difference occurring at the both ends of the control line GCB2. This is a reason why the power feeder 131 is disposed farther from the common line GCA of the control line unit GC and the power receiver 132 is disposed closer to the common line GCA.

Then, referring to FIG. 6B, the power feeder 131 and the power receiver 132 are separated from the control line GCB2 and are then connected to a control line GCB1. The power feeder 131 is connected to a lower portion of the control line GCB1 and the power receiver 132 is connected to an upper portion of the control line GCB1. Then, when a voltage is applied to the control line GCB1 by using the power feeder 131 and the power receiver 132, current flows through the control line GCB1. A potential difference occurs at both ends of the control line GCB1. Such a potential difference is monitored.

When a short circuit failure ST occurs in a region where the control line GCB1 and one of the second power supply lines V2 overlap with each other, a potential difference monitored at the both ends of the control line GCB1 and a potential difference monitored at the both ends of the control line GCB2 are different from each other.

It is possible to easily detect which of the control line GCB1 or GCB2 in which the short circuit failure ST occurs in a region overlapping with the second power supply line V2 by sequentially inspecting the control lines GCB as described above.

After the control line GCB1 in which the short circuit failure ST occurs is detected, a repair process including laser cutting may be performed on the control line GCB1.

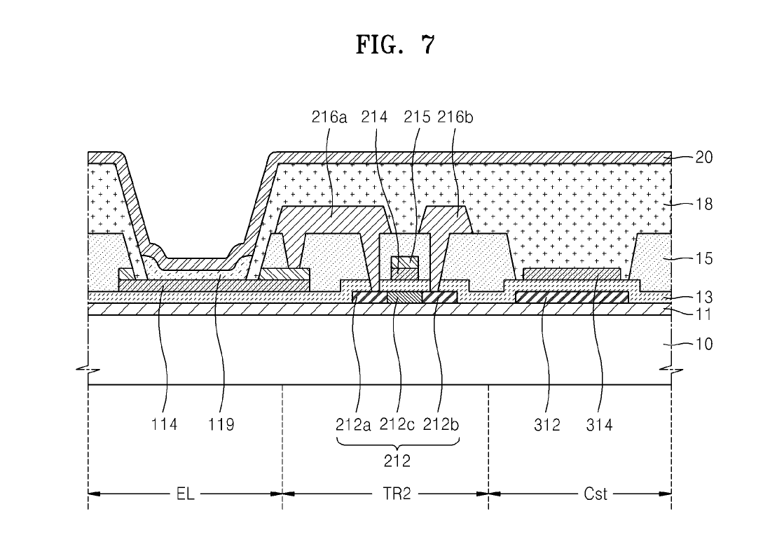

FIG. 7 is a cross-sectional view of some elements of each pixel of the organic light emitting display apparatus of FIG. 1, according to an embodiment of the present invention.

Referring to FIG. 7, a second transistor TR2 which is a thin film driving transistor, a first capacitor Cst, and an organic light emitting device OLED EL are disposed on a substrate 10. As described above, each pixel may include a first transistor TR1, a third transistor TR3, a second capacitor C2, and various wires, including, for example, a scan line S, a data line D, first and second power supply lines V1 and V2, and a control line unit GC, but only some elements of each pixel are illustrated in FIG. 7 for convenience of explanation.

The substrate 10 may be formed of a SiO₂-based transparent glass material, but is not limited thereto and may be formed of another transparent plastic material.

A buffer layer 11 may further be disposed on the substrate 10. The buffer layer 11 provides a flat surface on the substrate 10 and protects the substrate 10 against moisture and foreign substances.

An active layer 212 of the second transistor TR2 is formed on the buffer layer 11. The active layer 212 may be formed of an inorganic semiconductor, such as for example, amorphous silicon or poly silicon. The active layer 212 may also be formed of an organic semiconductor, an oxide semiconductor, or any of other various materials in other embodiments. The active layer 212 includes a source region 212b, a drain region 212a, and a channel region 212c.

A gate insulating layer 13 is disposed on the active layer 212. A first gate electrode layer 214 that contains a transparent conductive material, and a second gate electrode layer 215 are sequentially disposed on a location on the gate insulating layer 13 corresponding to the channel region 212c of the active layer 212.

A source electrode 216b and a drain electrode 216a are formed over the second gate electrode layer 215 after forming an interlayer insulating layer 15 to be connected to the source region 212b and the drain region 212a of the active layer, respectively.

A pixel defining layer 18 is formed on the interlayer insulating layer 15 to cover the source electrode 216b and the drain electrode 216a.

Although not shown in FIG. 7, the first transistor TR1 and the third transistor TR3 may have the same structure as that of the second transistor TR2.

The data line D may be formed on a layer where the source electrode 216b or the drain electrode 216a is disposed by using a material used to form the source electrode 216b or the drain electrode 216a. Similar to the data line D, control lines GCB of the control line unit GC may be formed on the layer where the source electrode 216b or the drain electrode 216a is disposed by using the material used to form the source electrode 216b or the drain electrode 216a. The first power supply line V1 may also be formed on the layer where the source electrode 216b or the drain electrode 216a is disposed by using the material used to form the source electrode 216b or the drain electrode 216a.

The scan line S may be formed on a layer where the first gate electrode layer 214 or the second gate electrode layer 215 is disposed by using a material used to form the first gate electrode layer 214 or the second gate electrode layer 215. Similar to the scan line S, the second power supply line V2 may be formed on the layer where the first gate electrode layer 214 or the second gate electrode layer 215 is disposed by using the material used to form the first gate electrode layer 214 or the second gate electrode layer 215.

A pixel electrode 114 is formed on the gate insulating layer 13 by using the transparent conductive material used to form the first gate electrode layer 214. The transparent conductive material may include at least one material selected from the group consisting of indium tin oxide (ITO), indium zinc oxide (IZO), zinc oxide (ZnO), indium oxide (In₂O₃), indium gallium oxide (IGO), and aluminum zinc oxide (AZO).

An intermediate layer 119 including an organic emission layer is formed on the pixel electrode 114.

The organic emission layer of the intermediate layer 119 may be formed of a low-molecular weight organic material or a high-molecular weight organic material. If the low-molecular weight organic material is used, then a hole transport layer (HTL), a hole injection layer (HIL), an electron transport layer (ETL), and an electron injection layer (EIL) may be stacked around the organic emission layer. In addition, other various layers may further be stacked if needed. In this case, examples of an organic material, such as copper phthalocyanine (CuPc), N′-Di(naphthalene-1-yl)-N, N′-diphenyl-benzidine (NPB), and tris-8-hydroxyquinoline aluminum (Alq3), may be used.

If the high-molecular weight organic material is used, the intermediate layer 119 may include not only the organic emission layer but also an HTL. The HTL may be poly-(3,4)-ethylene-dihydroxy thiophene (PEDOT) or polyaniline (PANI). In this case, an organic material, e.g., a poly-phenylenevinylene (PPV)-based high-molecular weight organic material or a polyfluorene-based -based high-molecular weight organic material, may be used.

An opposite electrode 20 is formed as a common electrode on the intermediate layer 119. In various embodiments, the pixel electrode 114 may function as an anode and the opposite electrode 20 may function as a cathode, or vice versa.

The opposite electrode 20 may be a reflective electrode containing a reflective material. In such embodiments, the opposite electrode 20 may include at least one material selected from the group consisting of aluminum (Al), magnesium (Mg), lithium (Li), calcium (Ca), lithium fluoride/calcium (LiF/Ca), and lithium fluoride/aluminum (LiF/Al).

A lower electrode 312 and an upper electrode 314 of the first capacitor Cst are formed on the substrate 10 and the buffer layer 11. The lower electrode 312 is formed of a material used to form the active layer 212 of the second transistor TR2 which is a thin film driving transistor. The upper electrode 314 includes a transparent conductive material formed of a material used to form the pixel electrode 114. The gate insulating layer 13 is disposed between the lower electrode 312 and the upper electrode 314.

A sealing member (not shown) may be disposed on the opposite electrode 20 to face one surface of the substrate 10. The sealing member is formed to protect the intermediate layer 119 from external moisture, oxygen, or the like. The sealing member may be formed of glass or plastic or may have a structure in which organic materials and inorganic materials overlap with one another.

According to the above embodiments, an organic light emitting display apparatus may be easily inspected to determine whether an electrical failure occurs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An organic light emitting display apparatus comprising:
a plurality of pixels each including a pixel electrode, an intermediate layer including an organic emission layer, and an opposite electrode;
a plurality of scan lines and a plurality of data lines corresponding to the plurality of pixels;
first power supply lines connected to the plurality of pixels and extending in a first direction;
second power supply lines connected to the first power supply lines; and
a controller for simultaneously supplying control signals to the plurality of pixels, the controller including a plurality of control lines and a common line, wherein the common line is connected to a first end of each of the plurality of control lines and is separated from a second, opposing end of each of the plurality of control lines.

2. The organic light emitting display apparatus of claim 1, wherein the second power supply lines extend in a second direction intersecting the first direction.

3. The organic light emitting display apparatus of claim 1, wherein the control lines extend in the first direction.

4. The organic light emitting display apparatus of claim 1, wherein the control lines are disposed on a layer on which the first or second power supply voltages are not disposed, and
the first or second power supply voltages intersect the control lines.

5. The organic light emitting display apparatus of claim 1, wherein the control lines are disposed on a layer on which the first power supply lines are disposed, and are disposed on a layer on which the second power supply lines are not disposed so as to intersect the second power supply voltages.

6. The organic light emitting display apparatus of claim 1, wherein the control lines are disposed on a layer on which the plurality of data lines are disposed.

7. The organic light emitting display apparatus of claim 1, wherein the first power supply lines are disposed on a layer on which the plurality of data lines are disposed.

8. The organic light emitting display apparatus of claim 1, wherein the second power supply lines are disposed on a layer on which the plurality of scan lines are disposed.

9. The organic light emitting display apparatus of claim 1, wherein each pixel of the plurality of pixels comprises at least three thin film transistors and at least two capacitors.

10. The organic light emitting display apparatus of claim 9, wherein the controller is electrically connected to a gate electrode of one of the at least three thin film transistors.

11. The organic light emitting display apparatus of claim 9, wherein at least one of the at least three thin film transistors comprises an active layer, a first gate electrode layer, a second gate electrode layer formed on the first gate electrode layer, a source electrode, and a drain electrode, and
the pixel electrode is formed on a layer on which the first gate electrode layer is formed by using a material used to form the first gate electrode layer.

12. A method of inspecting an organic light emitting display apparatus which includes a plurality of pixels each including a pixel electrode, an intermediate layer including an organic emission layer, and an opposite electrode, a plurality of scan lines and a plurality of data lines corresponding to the plurality of pixels, first power supply lines connected to the plurality of pixels and extending in a first direction, second power supply lines connected to the first power supply lines, and a controller that simultaneously supplies control signals to the plurality of pixels and includes a plurality of control lines and a common line connected to a first end of each of the plurality of control lines and separated from a second, opposing end of each of the plurality of control lines, the method comprising applying a voltage to one of the control lines by connecting a power receiver to a region of the first end of the control line, which is disposed apart from the common line, and connecting a power feeder to a region of the control line that is disposed farther from the common line than the region connected to the power receiver.

13. The method of claim 12, further comprising monitoring a potential difference between the region of the control line connected to the power receiver and the region of the control line connected to the power feeder.

14. The method of claim 12, further comprising sequentially applying a voltage to the plurality of control lines by sequentially connecting the power receiver and the power feeder to the plurality of control lines.

15. The method of claim 12, wherein a voltage is sequentially applied to the plurality of control lines so as to inspect whether a short circuit failure occurs between each of the control lines and each of the first power supply lines or between each of the control lines and each of the second power supply lines.
